(19) United States
(12) Patent Application Publication
(10) Pub. No.: US 2014/0118203 A1
(43) Pub. Date: May 1, 2014

(54) COAX COUPLED SLOT ANTENNA

(71) Applicant: John R. Sanford, Encinitas, CA (US)

(72) Inventor: John R. Sanford, Encinitas, CA (US)

(21) Appl. No.: 13/666,896

(22) Filed: Nov. 1, 2012

(51) Int. Cl. H01Q 13/10; H01P 11/00; H01Q 21/00

(52) U.S. Cl. 343/725; 343/771; 29/600

(57) ABSTRACT

A device comprising an elongated structural member, said member including a dielectric material such as air or other suitable dielectric disposed inside the member and having a microstrip disposed axially in the dielectric material. The member may have a series of slots positioned at a predetermined distance with each slot having a portion transverse to the disposition of the microstrip, and a portion parallel to the disposition of the microstrip. In operation RF power from the microstrip radiates through the slots according to a desired radiation pattern. Some embodiments may have arrays of patch antennas positioned to radiate in a direction to complement the radiation pattern of the slots. The slots may be formed asymmetrical or symmetrical to achieve a desired radiation pattern. Some embodiments provide for omni-directional radiation in horizontal polarization. When patches arrays are added the structure may provide dual (vertical and horizontal) polarization.

### BACKGROUND

The present invention relates generally to antennas and more particularly to an antenna design for microwave systems.

Conventionally a slot antenna consists of a metal surface, usually a flat plate, with a hole or slot cut out of the plate. When the plate is driven as an antenna by a driving frequency, the slot radiates electromagnetic waves in similar way to a dipole antenna. The shape and size of the slot, as well as the driving frequency, determine the radiation distribution pattern. Often the radio waves are provided by a waveguide, and the antenna consists of slots in the waveguide. Slot antennas are often used at UHF and microwave frequencies instead of line antennas when greater control of the radiation pattern is required. Slot antennas may be widely used in radar antennas and for cell phone base station antennas. A slot antenna may provide an advantage in size, design simplicity, robustness, and cost of manufacture.

Conventionally a patch antenna is a narrowband, wide-beam antenna fabricated by etching the antenna element pattern in metal trace bonded to an insulating dielectric substrate, such as a printed circuit board, with a continuous metal layer bonded to the opposite side of the substrate which forms a ground plane. Common microstrip antenna shapes are square, rectangular, circular and elliptical, but other continuous shapes may be effectuated. Some conventional patch antennas do not use a dielectric substrate and instead comprise a metal patch mounted above a ground plane using dielectric spacers resulting in a wider bandwidth.

### SUMMARY

Disclosed herein is a device comprising an elongated structural member, said member including a dielectric material such as air or other suitable dielectric disposed inside the member and having a microstrip disposed axially in the dielectric material. The microstrip may be on a circuit board or may be positioned within the member using insulating material. The width of the member may be formed to be approximately one half of the wavelength of the desired operating frequency. The member may have a series of slots positioned at a predetermined distance with each slot having a portion transverse to the disposition of the microstrip, and one or more portions parallel to the disposition of the microstrip. In some embodiments the shape of the slot determines the amount of power radiated by the slot and the direction of radiation. The slots may be positioned on more than one side of the structural member.

In operation RF power applied to the microstrip radiates through the slots according to a desired radiation pattern. The slots may be formed asymmetrical or symmetrical to achieve a desired radiation pattern. Some embodiments may also have arrays of patch antennas positioned to radiate in a direction to complement the radiation pattern of the slots. Combinations of patch arrays and slots may be effectuated to achieve omni-directional radiation patterns. Some embodiments provide for omni-directional radiation in horizontal polarization and when patches arrays are added the structure may provide dual (vertical and horizontal) polarization.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 illustrates certain concepts which may be used in the design and construction of a coax microstrip coupled slot antenna.

FIG. 2 shows an embodiment of certain aspects of coax microstrip coupled slot antenna according to the current disclosure.

FIG. 3 shows a support structure having 4 slots, each slot having different length radiating regions.

FIG. 4 illustrates an embodiment of a coax microstrip coupled slot antenna according to some aspects of the present disclosure.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Read this application with the following terms and phrases in their most general form. The general meaning of each of these terms or phrases is illustrative, not in any way limiting.

### Lexicography

The terms “antenna”, “antenna system” and the like, generally refer to any device that is a transducer designed to transmit or receive electromagnetic radiation. In other words, antennas convert electromagnetic radiation into electrical currents and vice versa. Often an antenna is an arrangement of conductor(s) that generate a radiating electromagnetic field in response to an applied alternating voltage and the associated alternating electric current, or can be placed in an electromagnetic field so that the field will induce an alternating current in the antenna and a voltage between its terminals.

The phrase “wireless communication system” generally refers to a coupling of EMF's (electromagnetic fields) between a sender and a receiver. For example and without limitation, many wireless communication systems operate with senders and receivers using modulation onto carrier frequencies of between about 2.4 GHz and about 5 GHz. However, in the context of the invention, there is no particular reason why there should be any such limitation. For example and without limitation, wireless communication systems might operate, at least in part, with vastly distinct EMF frequencies, e.g., ELF (extremely low frequencies) or using light (e.g., lasers), as is sometimes used for communication with satellites or spacecraft.

The phrase “access point”, the term “AP”, and the like, generally refer to any devices capable of operation within a wireless communication system, in which at least some of their communication is potentially with wireless stations. For example, an “AP” might refer to a device capable of wireless communication with wireless stations, capable of wire-line or wireless communication with other AP's, and capable of wire-line or wireless communication with a control unit. Additionally, some examples AP's might communicate with devices external to the wireless communication system (e.g., an extranet, internet, or intranet), using an L2/L3 network. However, in the context of the invention, there is no particular reason why there should be any such limitation. For example one or more AP's might communicate wirelessly, while zero or more AP's might optionally communicate using a wire-line communication link.

The term “filter”, and the like, generally refers to signal manipulation techniques, whether analog, digital, or otherwise, in which signals modulated onto distinct carrier frequencies can be separated, with the effect that those signals can be individually processed.

By way of example only, in systems in which frequencies both in the approximately 2.4 GHz range and the approximately 5 GHz range are concurrently used, it might occur that a single band-pass, high-pass, or low-pass filter for the approximately 2.4 GHz range is sufficient to distinguish the approximately 2.4 GHz range from the approximately 5 GHz range, but that such a single band-pass, high-pass, or low-pass filter has drawbacks in distinguishing each particular channel within the approximately 2.4 GHz range or has drawbacks in distinguishing each particular channel within the approximately 5 GHz range. In such cases, a 1st set of signal filters might be used to distinguish those channels collectively within the approximately 2.4 GHz range from those channels collectively within the approximately 5 GHz range. A 2nd set of signal filters might be used to separately distinguish individual channels within the approximately 2.4 GHz range, while a 3rd set of signal filters might be used to separately distinguish individual channels within the approximately 5 GHz range.

The phrase “isolation technique”, the term “isolate”, and the like, generally refer to any device or technique involving reducing the amount of noise perceived on a 1st channel when signals are concurrently communicated on a 2nd channel. This is sometimes referred to herein as “crosstalk”, “interference”, or “noise”.

The phrase “null region”, the term “null”, and the like, generally refer to regions in which an operating antenna (or antenna part) has relatively little EMF effect on those particular regions. This has the effect that EMF radiation emitted or received within those regions are often relatively unaffected by EMF radiation emitted or received within other regions of the operating antenna (or antenna part).

The term “radio”, and the like, generally refer to (1) devices capable of wireless communication while concurrently using multiple antennae, frequencies, or some other combination or conjunction of techniques, or (2) techniques involving wireless communication while concurrently using multiple antennae, frequencies, or some other combination or conjunction of techniques.

The phrase “wireless station” (WS), “mobile station” (MS), and the like, generally refer to devices capable of operation within a wireless communication system, in which at least some of their communication potentially uses wireless techniques.

The phrases “patch” and “patch antenna” generally refers to an antenna formed by suspending a single metal patch over a ground plane. The assembly may be contained inside a plastic radome, which protects the antenna structure from damage. A patch antenna is often constructed on a dielectric substrate to provide for electrical isolation.

The phrase “dual polarized” generally refers to antennas or systems formed to radiate electromagnetic radiation polarized in two modes. Generally the two modes are horizontal radiation and vertical radiation.

### DETAILED DESCRIPTION

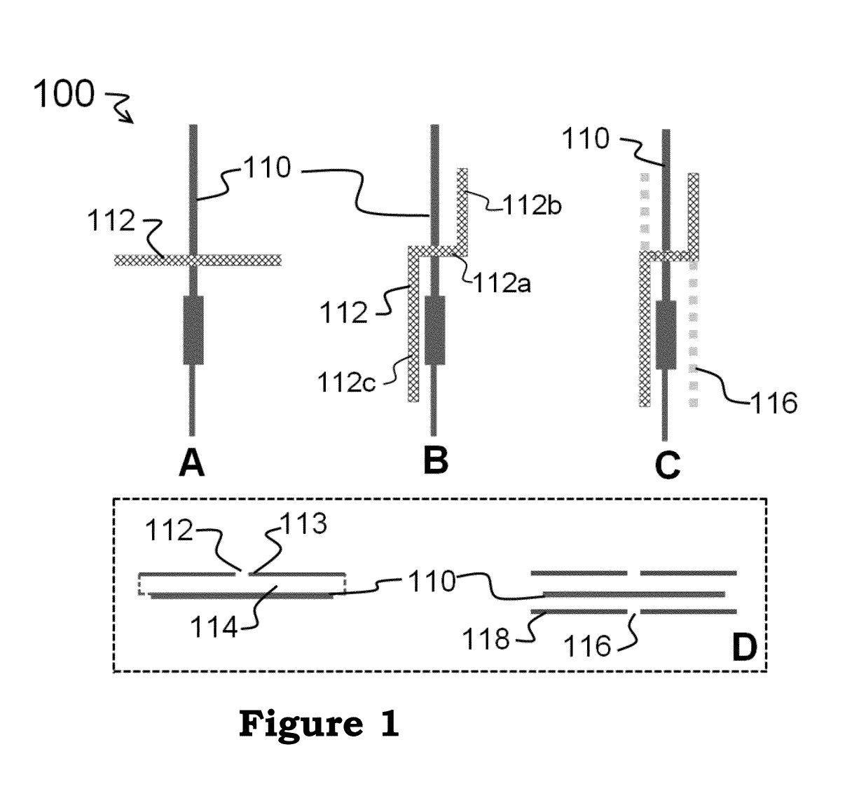

FIG. 1 illustrates certain concepts 100 which may be used in the design and construction of a coax microstrip coupled slot antenna. FIGS. 1A, 1B and 1C represent a “top views” while FIG. 1D is a representative “side view.” In FIG. 1A a microstrip 110 is disposed orthogonally to a slot 112. The microstrip may be formed by a thin layer of conductive material disposed on a substrate such as a circuit board or film. The slot 112 is formed as an opening in the conductive material 113 (shown in FIG. 1D) 113. The microstrip 110 and the slot 112 are further separated by a dielectric 114 while maintaining the transverse relationship between the microstrip 110 and the slot 112. In some embodiments the dielectric 114 may be an air gap or circuit board material. In operation when RF energy is induced upon the microstrip 110 it will radiate out the slot 112.

In FIG. 1B a portion of the slot 112 is disposed orthogonally to the microstrip 110 designated as portion 112a. The slot in FIG. 1B also has two portions parallel to the microstrip 110, designated as portions 112b and 112c. In certain embodiments the parallel portions may be the same length, while other embodiments may use varying degrees of length differences. Similarly to FIG. 1A, the microstrip 110 and the slot 112 are separated by a dielectric 114 which may be air.

In FIG. 1C a microstrip 110 is disposed near a slot 116. The slot 116 is shown disposed on a side opposite the slot 112. The slot 116 has a portion orthogonal to the microstrip 110 and portions parallel to the microstrip 110. In certain embodiments the parallel portions of the slot 116 may align with the parallel portions of the slot 112, while in other embodiments the parallel portions may be reciprocal as shown. The double-sided embodiment of FIG. 1C is shown from a side angle in FIG. 1D. In FIG. 1D the microstrip 110 is disposed between a first conducting structure 113 having a slot 112 shown on the top side of FIG. 1D. A second conducting structure 118, which may be integrally formed with structure 113, is disposed opposite the slot 112. The second structure 118 has a slot 116 as shown on the bottom of FIG. 1D.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

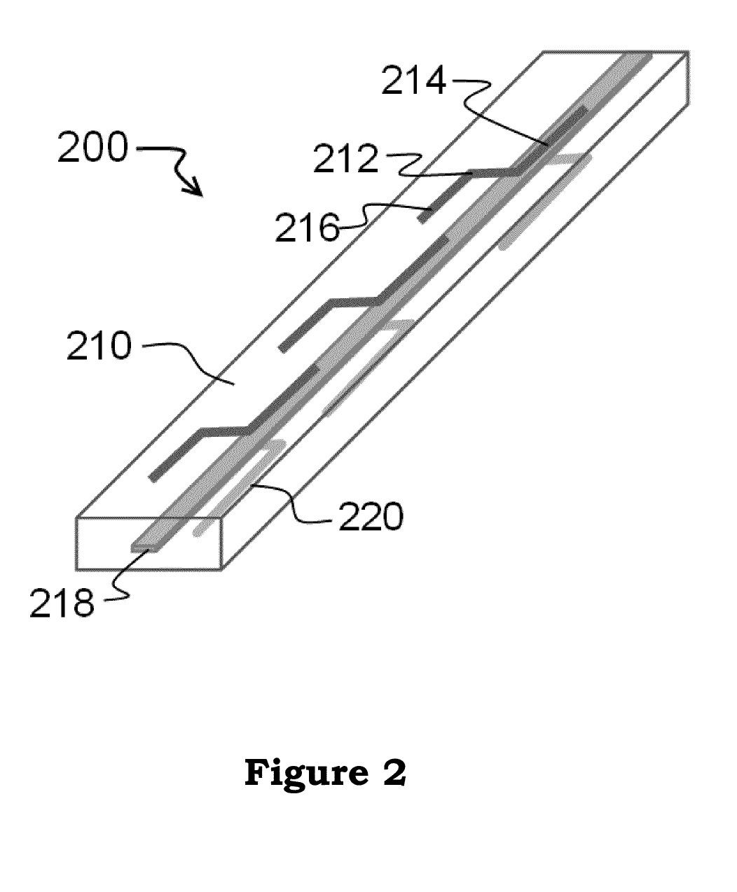

FIG. 2 shows an embodiment of certain aspects of coax microstrip coupled slot antenna according to the current disclosure. In FIG. 2 antenna structure 210 is the shown as substantially rectangular. The antenna structure 210 may be formed from extruded aluminum, another conductive material or any material meeting a particular design requirement. The antenna structure 210 has slots in two surfaces (front and back). Each slot includes first orthogonal element 210 a parallel element 214 and a parallel element 216. The slots may be formed by milling or otherwise cutting the slots from the antenna structure 210.

Disposed in the center of the antenna structure 210 is a microstrip 218. The microstrip 218 may be held in place using spacers (not shown), or may be disposed on a printed circuit board (not shown) which can be slid into the center of the antenna structure 210. In certain embodiments tabs or other support elements hay be formed internal to the antenna structure 210 for holding the microstrip 218. The microstrip 218 and antenna structure 210 is coupled to a radio transmitter or receiver (not shown). The microstrip 218 is disposed such that the orthogonal element 212 of a slot is aligned substantially orthogonal to the microstrip 218. The parallel elements 214 and 216 are aligned parallel to the microstrip. The space between the microstrip 218 and the slot is a dielectric material such as air.

In operation RF energy would be imposed on the microstrip 218. The slots would act as radiators for the RF energy and direct radiated RF out of the slots. The inventor contemplates that RF energy coupled to the microstrip 218 may be impedance matched with the cavity formed by the center of the antenna structure 210 and the slots. Additionally, the inventor contemplates that the slots would be positioned at intervals corresponding to the wavelength of the RF signal coupled to the microstrip 218. A designer may position slots at or near a single wavelength interval thus effectuating a predetermined RF operating range and the RF radiation pattern desired for a specific design. In certain embodiments some slots may be positioned at single wavelength intervals while other are spaced differently.

This disclosure should not be read as limiting the shape of the slots in any way. For example and without limitation, the slots may be effectuated as a single element transverse to the microstrip, or as different shapes including arcs, crossbars, and the like. Moreover, irregular shapes and combinations of unconnected elements that allow for radiation from the microstrip may also be effectuated using the technique described herein.

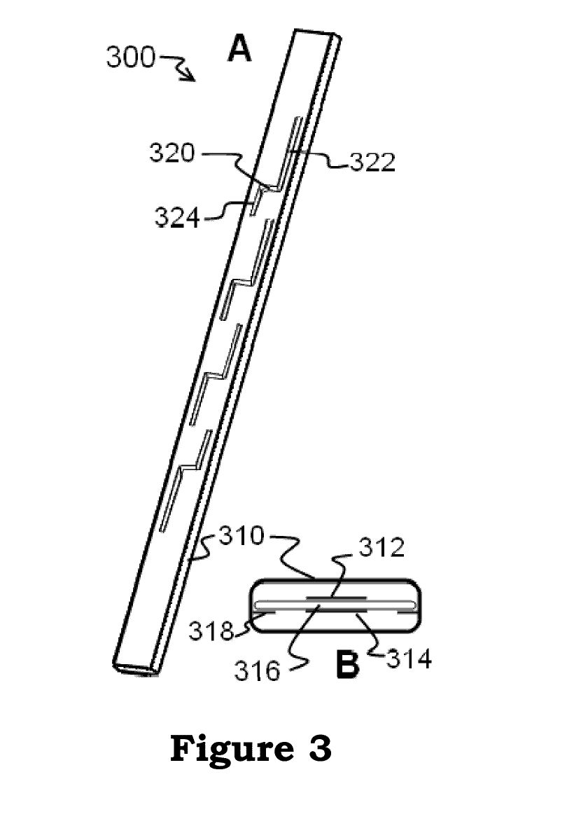

FIG. 3 show another embodiment of an aspect of a coax microstrip coupled slot antenna 300. FIG. 3A shows a perspective view and FIG. 3B shows a cross sectional view. In FIG. 3 an elongated support structure 310 has a hollow center. In the center is a circuit board 310 having a top microstrip 312. The inventor contemplates using only a top microstrip 312, however, certain embodiments may also employ a bottom microstrip 314. The top and bottom microstrip may be disposed on a circuit board 316 held into the center of the support structure 310 by side supports 318. Alternatively the microstrip 312 may be held in place using dielectric insulators. The support structure 310 has multiple slots with each slot having a horizontal portion disposed orthogonally to the axis of a microstrip. In certain embodiments the support structure 310 may have slots on multiple sides corresponding to the positions of any microstrip disposed within the support structure 310.

The dimensions of the hollow center of the support structure 310 generally conform to coaxial transmission line characteristics. Because open-wire transmission lines have the property that the electromagnetic wave propagating down the line extends into the space surrounding the parallel wires, they have low loss, but also have undesirable characteristics. The disclosure of FIG. 3 solves these problems by confining the electromagnetic wave to the area inside the support structure 310 to allow for RF signal transmission. Impedance matching may be effectuated by control of the dimensions of the hollow center of the support structure 310.

The support structure 310 has slots along its length. In some embodiments, the support structure 310 has slots on both sides. These slots are open to the hollow center of the support structure 310. A slot generally comprises a horizontal region 320 opening transverse to the axis of the microstrip, a parallel region 322 aligned along the axis of the microstrip and another parallel region 324 aligned along the axis of the microstrip. The shape of the each slot may depend on the slots position on the support structure. For example and without limitation, the parallel region 322 may be a different length than the parallel region 324. In some embodiments the shape of each slot may depend on its position with respect to the microstrip.

FIG. 3 shows a support structure 310 having 4 slots each slot having different length parallel regions. The slots closest to the center of the support structure 310 are generally symmetrical, while the slots furthest from the center are asymmetrical. The degree of asymmetry in each slot may be employed to effect a desired radiation pattern from the slots. The overall size of a slot determines the amount of RF energy the slot will radiate, and control of the slot dimensions controls the radiation pattern. For example and without limitation, a larger slot may be constructed for an area of the support structure 310 that is furthest from the feed point of the microstrip. Similarly the horizontal regions 320 may also be constructed with different dimensions to effect desired radiation patterns.

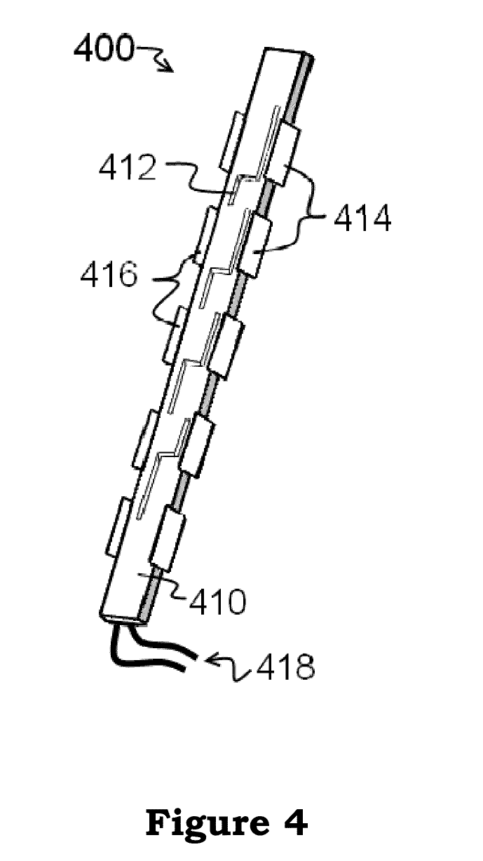

FIG. 4 illustrates an embodiment of a coax microstrip coupled slot antenna according to some aspects of the present disclosure. In FIG. 4 a hollow structure 410 is formed by extruding aluminum or forming a hollow tube out of some other suitable conductive material. The structure 410 includes a microstrip positioned within the hollow (not shown). The microstrip is coupled to a radio transmitter through coupling cables 418. Cut into the structure 410 are multiple slots 412. The slots are open to the hollow core of the structure 410. The slots 412 may have different shapes including, without limitation, a portion open across the width of the structure 410 and portions axially aligned to the structure 410.

Disposed along two sides of the structure 410 are arrays of patch antennas. The patch antennas may be supplied an RF excitation signal through coupling cables 418. In some embodiments the coupling cable 418 may be fed to a power divider to split RF transmitted energy before supplying it to the patch antenna arrays. One having skill in the art will recognize that the patch antenna arrays radiate as a vertical polarized beam in different directions from the radiation pattern of the slots and therefore provide a complementary radiation pattern. For example and without limitation, The patch arrays are generally positioned with a separation that provides good omni-directional performance when the patterns for each patch column are combined. Some embodiments may use a spacing of about half of a wavelength. The patch antenna arrays comprise elements which may be spaced approximately one wavelength apart. One having skill in the art will appreciate that some variation in the spacing of the array elements and number may be used to effectuate desire radiation affects such as a down tilt or to provide more bandwidth, or both.

In operation the omni-direction performance may be the result of the dual polarization with a first polarization (i.e. horizontal) provided by the slots and a second polarization (i.e. vertical) provided by the patch antennas. The microstrip may be driven by a separate RF feed, while the patch array may be drive by a second RF feed. The patch feed may be passed through a power splitter for providing sufficient power to each of the arrays.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A device comprising:
an elongated structural member, said member including a dielectric material disposed interior of the member;
a microstrip disposed substantially axially in the dielectric material;
a plurality of slots in the structural member, each of said slots having a portion substantially transverse to the disposition of the microstrip, and each of said slots having a portion substantially parallel to the disposition of the micro strip.

2. The device of claim 1 wherein the dielectric material is air.

3. The device of claim 1 wherein said transverse portion of said slots are disposed substantially one wavelength apart of a predetermined radio frequency.

4. The device of claim 1 wherein each slot has a plurality of portions substantially parallel to the disposition of the microstrip.

5. The device of claim 4 where the portions of the slots substantially parallel to the disposition of the microstrip are symmetrical.

6. The device of claim 4 where the portions of the slots substantially parallel to the disposition of the microstrip are asymmetrical.

7. The device of claim 1 wherein the microstrip is disposed on a circuit board.

8. The device of claim 1 further including:
one or more patch antennas, said patch antenna disposed exterior to the structural member.

9. The device of claim 8 wherein the one or more patch antennas are arranged into a first array.

10. The device of claim 9 further including a second patch antenna array disposed on the structural member opposite the first array.

11. The device of claim 10 wherein the width of the structural member is substantially one half wavelength apart of a predetermined radio frequency.

12. A method comprising:
determining a radio frequency;
forming a structural support in response to said determining where the width of structural support is substantially one half of the wavelength of the radio frequency, and the structural support includes a dielectric center;
disposing a microstrip interior to the structural support;
forming a plurality of slots through the structural support, said slots disposed substantially one wavelength apart.

13. The method of claim 12 wherein the slots include both a portion substantially transverse to the axis of the microstrip and a portion substantially parallel to the axis of the microstrip.

14. The method of claim 12 wherein the dielectric is air.

15. The method of claim 12 wherein the microstrip is disposed on substrate.

16. The method of claim 12 wherein said slots have a portion substantially transverse to the disposition of the microstrip, and each of said slots having a portion substantially parallel to the disposition of the microstrip.

17. The method of claim 12 further including:
disposing one or more patch antennas exterior to the structural support.

18. The method of claim 17 wherein the one or more patch antennas are disposed as an antenna array.

19. The method of claim 18 further including:
disposing a second antenna array exterior to the structural support.

20. The method of claim 19 further including:
positioning the antenna arrays and slots to effect a desired radiation pattern.

21. An antenna comprising:
a first portion for providing a substantially horizontally polarized radiation pattern, and
a second portion for providing a vertically polarized radiation pattern.

22. The device of claim 21 wherein the first portion includes at least one slot radiating element.

23. The device of claim 21 wherein the second potion includes at least one array antenna.

24. The device of claim 23 wherein the array antenna comprises a plurality of patch antennas.

25. A method comprising:
effecting a first polarized radiating element on a structure;
effecting a second polarized radiating element on said structure, said second polarized radiation element operative to radiate at a polarization substantially 90 degrees different from said first polarized radiating element.

26. The method of claim 25 wherein the first polarized radiation element includes a microstrip and a plurality of slots.

27. The method of claim 25 wherein the second polarized radiating element includes an antenna array.

28. The method of claim 27 wherein the antenna array is a patch antenna.
